(19) United States
(12) Patent Application Publication
(10) Pub. No.: US 2025/0206999 A1
(43) Pub. Date: Jun. 26, 2025

(54) AQUEOUS DIPPING BATH COMPOUNDS FOR TREATING REINFORCEMENT INSERTS AND THE USE THEREOF, AS WELL AS METHODS FOR PRODUCING AN ADHESIVE REINFORCEMENT INSERT

(71) Applicant: EMS-CHEMIE AG, Domat/Ems (CH)

(72) Inventors: Martin HOLZSCHUH, Domat/EMS (CH); Giacomo CONRAD, Sils im Domleschg (CH)

(73) Assignee: EMS-CHEMIE AG, Domat/Ems (CH)

(21) Appl. No.: 18/987,850

(22) Filed: Dec. 19, 2024

(30) Foreign Application Priority Data
Dec. 21, 2023 (EP) 23 219 281

(51) Int. Cl. C09J 109/08; C09J 11/06

(52) U.S. Cl. CPC C09J 109/08; C09J 11/06

(57) ABSTRACT

Disclosed is a dip bath composition for treating reinforcing inserts and their use for producing reinforced rubber products. The dip bath composition contains the following components: (A) at least one fully or partially blocked isocyanate; (B) at least one epoxy; and (C) at least one surfactant for enhancing wetting properties. Also disclosed are methods for producing adhesive reinforcing inserts.

### CROSS-REFERENCE TO A RELATED APPLICATION

This patent application claims the benefit of European Patent Application No. 23 219 281.5, filed on Dec. 21, 2023.

### BACKGROUND OF THE INVENTION

The present invention relates to dipping bath compounds for treating reinforcement inserts and to the use thereof for producing reinforced rubber products. The present invention furthermore relates to methods for producing an adhesive reinforcement insert.

It has proven to be advantageous in the production of reinforced rubber products if an adhesion promoter is used between the reinforcement insert and the rubber to enhance the adhesive strength. Such an adhesion promoter is important, in particular, in the field of belts serving as the reinforcement insert and other highly loaded composites containing reinforcement fibers. Solvent-containing dipping baths are utilized, in particular, for the use in the field of belts serving as a stiff application so as to achieve the necessary loading of the cords and the corresponding filament bonding and resulting stiffness for belts.

Adhesion promoters for producing adhesive reinforcement inserts are previously known from the prior art. Water-based dipping baths are used for soft cords, and solvent-based dipping baths are used for stiff cords. In terms of the process, either a one-step or a two-step method can be employed.

During the one-step method, the reinforcing element is impregnated with a mixture of resorcinol formaldehyde latex (RFL) or preferably resorcinol formaldehyde-free (RF-free) and an adhesion promoter.

During the two-step method, first the reinforcing element is impregnated with the adhesion promoter, and the RFL (or preferably RF-free) is applied in a second step.

A significant problem in the existing prior art with the solvent-containing dipping bath compounds is that special equipment including solvent post-combustion must be operated and, as a result, proper allowance must be made for explosion protection. Methylene diphenyl diisocyanates (MDI) serving as an active component in the solvent-containing process (for example in toluene) is hazardous to people's health and carcinogenic in the form of a free isocyanate.

### BRIEF SUMMARY OF THE INVENTION

A significant problem in the existing prior art with the solvent-free dipping bath compounds is that the filament bonding is not sufficient for the use as stiff cords.

Proceeding from this, it was the object of the present invention to provide a dipping bath compound that makes it possible to produce reinforcement inserts for rubber products that have very good adhesion properties, in particular very good adhesion in the peel adhesion test (referred to as H-test), and a good degree of surface coverage following the H-test, without the above-discussed problems, which result from the use of solvents, occurring.

This object is achieved by the aqueous, solids-containing dipping bath compound according to the invention and as described herein for treating reinforcement inserts, by the method for producing an adhesive reinforcement insert according to the invention, to the adhesive reinforcement insert according to the invention, and to the use thereof according to the invention. Advantageous refinements according to the invention are also described.

According to the invention, at least one aqueous, solids-containing dipping bath compound for treating reinforcement inserts is provided, which contains the following components or is made up of these components:
(A) at least one fully or partially blocked isocyanate;
(B) at least one epoxy;
(C) at least one surfactant for enhancing the wetting properties, the at least one surfactant (C) being selected from the group consisting of anionic surfactants, cationic surfactants, non-ionic surfactants, amphoteric surfactants, silicon-containing surfactants, perfluorinated surfactants, hydrophilically modified polyolefins and mixtures thereof, particularly preferably from the group consisting of soaps, alkylbenzene sulfonates, linear alkylbenzene sulfonates, alkane sulfonates, ester sulfonates, methylester sulfonates, sulfosuccinic acid derivatives, α-olefin sulfonates, alkyl sulfates, fatty alcohol sulfates, fatty alcohol ether sulfates, fatty alcohol polyglycol ether sulfates, fatty alcohol polyglycol ether, dioctyl sodium sulfosuccinate, alkylphenol polyglycol ether, sorbitan fatty acid esters, ethoxylated sorbitan fatty acid esters, alkyl polyglucosides, fatty acid glucamides, fatty acid ethoxylates, fatty amine ethoxylates, ethoxylated triacylglycerols, polyethylene glycol ethers alkylated on both sides, alcohol ethoxylates, nonylphenol ethoxylates, polyglycerol fatty acid esters, fatty acid alkanolamides, amine oxides, alkyldimethylamine oxides, alkyl polyglucosides, saccharose esters, sorbitan esters, fatty acid glucamides, fatty acid N-methyl glucamides, ampholytes, betaines, sulfobetaines, N-(acylamidoalkyl) betaines, N-alkyl-β-aminopropionates, N-alkyl-β-iminopropionates, salts of long-chain primary amines, quarternary ammonium salts, quarternary phosphonium salts, tertiary sulfonium salts, pyridinium salts, imidazolinium salts, oxazolinium salts, esterquats, polyalkylene glycols, alkoxylated polyalkylene glycols, polysulfones, poly(2-hydroxyalkyl acrylates), poly(2-hydroxyalkyl methacrylates), ethylene oxide-propylene oxide block copolymers, polyethylene glycols, polypropylene glycols, polyethylene oxide resins, polypropylene oxides, salts of oligophosphates, salts of polyphosphates and mixtures thereof;
(D) at least one latex selected from the group consisting of styrene-butadiene-vinylpyridine copolymer, styrene-butadiene-vinylpyridine copolymer modified with carboxylic acid, styrene-butadiene copolymer, styrene-butadiene copolymer modified with carboxylic acid, nitrile-butadiene copolymer, natural latex, chloroprene latex and mixtures thereof; as well as
(E) optionally at least one additive selected from the group consisting of
   defoamers, preferably long-chain alcohols, high-polymeric glycols, trialkylmethylamines, silicones or mixtures thereof, particularly preferably silicones in the form of silicone emulsions;
   organic polymers, preferably polylignins, lignin sulfonic acids, kraft lignins;
   fillers, preferably silicates;
   dyes, preferably carbon black;
   preservatives;
   catalysts;
   thickeners;
   acids;
   lyes;
   polyhydric alcohols; and
   mixtures thereof.

### DEFINITIONS OF TERMS

The dipping bath compounds according to the invention are aqueous, that is, water is used as the liquid phase. Water is not listed hereafter as a component of the dipping bath compound. The dipping bath compound is preferably substantially free of organic solvents, that is, of organic liquids that are not involved in the reactions. Substantially free shall be understood to mean that less than 5 wt. %, preferably less than 2 wt. % organic solvents is present, based on the total weight of the dipping bath compound. The dipping bath compound is preferably completely free of organic solvents.

In addition, the dipping bath compounds according to the present invention are preferably substantially free of resorcinol and formaldehyde and the reaction products thereof, that is, in sum contain less than 1.0 wt. %, preferably less than 0.5 wt. %, particularly preferably less than 0.16 wt. % is present, each based on the total weight of the dipping bath compound. Particularly preferably, the dipping bath compounds are completely free of resorcinol and formaldehyde and the reaction products thereof.

The dipping bath compounds according to the invention can be present in the form of a single bath or in the form of multiple baths, in particular two baths.

The terms “containing” and “comprising” in the present claims and in the description shall be understood to mean that further components are not precluded. Within the scope of the present invention, the term “made up of” shall be understood to mean a preferred embodiment of the terms “containing” or “comprising”. Where it is defined that a group “contains” or “comprises” at least certain number of components, this shall also be understood to mean that a group is disclosed which is preferably “made up of” these components.

### Dipping Bath Compound

Preferred embodiments of the dipping bath compound according to the invention are described hereafter.

According to a preferred embodiment of the present invention, the solids content of the dipping bath compound is 2 to 40 wt. %, preferably 3 to 30 wt. %, particularly preferably 4 to 22 wt. %, and still more preferably 5 to 16 wt. %, based on the total weight of the dipping bath compound, including water.

According to another preferred embodiment, the aqueous, solids-containing dipping bath compound has the following composition, wherein the parts by weight in each case are based on the total weight of 200 parts by weight of the dipping bath compound, including water:
(A) 0.1 to 18.0 parts by weight, preferably 0.2 to 16.0 parts by weight, particularly preferably 1.0 to 14 parts by weight, and still more preferably 3.0 to 13 parts by weight;
(B) 0.4 to 8.0 parts by weight, preferably 0.7 to 6.0 parts by weight, particularly preferably 1.0 to 4.0 parts by weight, and still more preferably 1.2 to 3.0 parts by weight;
(C) 0.01 to 5.0 parts by weight, preferably 0.02 to 2 parts by weight, particularly preferably 0.05 to 0.50 parts by weight, and still more preferably 0.10 to 0.30 parts by weight;
(D) 5 to 40 parts by weight, preferably 8 to 30 parts by weight, and particularly preferably 12 to 25 parts by weight, and still more preferably 15 to 20 parts by weight; and
(E) 0 to 20 parts by weight, preferably 0.1 to 10 parts by weight, and particularly preferably 0.1 to 5 parts by weight, and still more preferably 0.1 to 3, each based on the solids content.

According to another preferred embodiment, the aqueous, solids-containing dipping bath compound is divided among multiple baths, in particular two baths. In the case of two baths, the two baths comprise the following components:

### Bath 1:

(A) at least one fully or partially blocked isocyanate;
(B) at least one epoxy;
(C) at least one surfactant for enhancing the wetting properties, and optionally
(E) at least one additive.

### Bath 2:

(D) at least one latex;
   and optionally
(A) at least one fully or partially blocked isocyanate;
   and optionally
(E) at least one additive.

According to the present invention, in particular lactam-blocked isocyanates have proven to be advantageous blocking agents in terms of the isocyanates. Examples are ε-caprolactam and δ-valerolactam. The invention, however, of course also encompasses other known blocking agents. These are preferably selected from the group consisting of
monophenols, in particular phenol, resorcinol, cresol, trimethylphenols and tert-butylphenols;
lactams, in particular ε-caprolactam, δ-valerolactam, and laurolactam;
primary, secondary, and tertiary alcohols, glycol ether;
oximes, in particular methyl ethyl ketoxime, methyl amyl ketoxime, and cyclohexanone oxime;
enol-forming compounds, in particular ethyl acetoacetate, acetylacetone;
secondary aromatic amines;
imides;
mercaptanes;
triazole, and
mixtures thereof.

The blocking agent is preferably selected from the group consisting of monophenols, in particular phenol, cresol, trimethylphenols and tert-butylphenols; lactams, in particular ε-caprolactam, δ-valerolactam, and laurolactam; and mixtures thereof, and particularly preferably the capping agent is selected from the group consisting of phenol, ε-caprolactam, and mixtures thereof. It is most preferred when the MDI mixture (A) is capped with ε-caprolactam.

It has furthermore proven to be advantageous with respect to the adhesion promoter formulation when the isocyanates used are methylene diphenyl diisocyanate (MDI) and/or toluene diisocyanate (TDI) and/or 1,5-naphthalene diisocyanate (NDI). The invention, however, of course also encompasses all other known isocyanates that can be used for such adhesion promoter formulations. Reference in this regard is made by way of example to US2002/0122938 A1 and the diisocyanates described there.

According to another preferred embodiment of the present invention, the capped MDI mixture (A) contains MDI derivatives (that is, modified MDI), which are preferably selected from the group consisting of MDI uretdione, adducts of MDI and/or MDI oligomers with other compounds.

According to another preferred embodiment of the present invention, the MDI is selected from the group consisting of 4,4′-MDI, 2,4′-MDI, 2,2′-MDI and mixtures thereof, with the content of 2,4′-MDI and 2,2′-MDI preferably being smaller than 10 wt. %, preferably smaller than 8 wt. %, and particularly preferably in the range of 0.1 to 6 wt. %, in each case based on the MDI mixture.

According to a preferred embodiment, the mixture contains one or more MDI oligomers, wherein n in Formula (I) is an integer from 1 to 8, and preferably from 1 to 6:

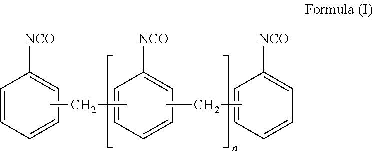

According to another preferred embodiment according to the invention, the MDI mixture has the following composition:
(i) 25 to 60 wt. %, preferably 25 to 49.9 wt. % MDI monomers;
(ii) 40 to 75 wt. %, preferably 50 to 74.9 wt. % MDI oligomers; and
(iii) 0 to 9 wt. %, preferably 0.1 to 6 wt. % modified MDI, with the contents of components (i) to (iii) adding up to 100 wt. %.

MDI mixtures made of MDI oligomers of Formula (I), MDI monomers, and optionally MDI derivatives are commercially available by the designation “polymeric MDI” (PMDI), for example as Voronate (DowDuPont), Suprosec (Huntsman), Elastoflex (BASF), Lupronat (BASF), or Autofroth (BASF).

According to another preferred embodiment of the present invention, the at least one epoxy (B) is soluble in the dispersion and/or has a molecular weight of 50 to 2000 g/mol. Particularly preferred are epoxy resins having a molecular weight of 100 to 1000, in particular water-soluble polyglycidyl ethers, epoxy novolac resins, polyfunctional alkylene epoxy resins, diglycidyl ethers and bisphenol A on based resins. The invention, however, also encompasses all epoxy resins cited in EP 1 221 456 A1. Particularly preferably invention, the at least one epoxy (B) is selected from the group consisting of water-soluble polyglycidyl ethers, polyfunctional alkylene epoxy resins, diglyidyl ethers, and mixtures thereof.

According to another embodiment of the present invention, the at least one surfactant (C) is selected from the group consisting of anionic surfactants, cationic surfactants, non-ionic surfactants, amphoteric surfactants, silicon-containing surfactants, perfluorinated surfactants, hydrophilically modified polyolefins, and mixtures thereof. The surfactants are preferably selected from the group consisting of soaps, alkylbenzene sulfonates, linear alkylbenzene sulfonates, alkane sulfonates, ester sulfonates, methylester sulfonates, sulfosuccinic acid derivatives, α-olefin sulfonates, alkyl sulfates, fatty alcohol sulfates, fatty alcohol ether sulfates, fatty alcohol polyglycol ether sulfates, fatty alcohol polyglycol ether, dioctyl sodium sulfosuccinate, alkylphenol polyglycol ether, sorbitan fatty acid esters, ethoxylated sorbitan fatty acid esters, alkyl polyglucosides, fatty acid glucamides, fatty acid ethoxylates, fatty amine ethoxylates, ethoxylated triacylglycerols, polyethylene glycol ethers alkylated on both sides, alcohol ethoxylates, nonylphenol ethoxylates, polyglycerol fatty acid esters, fatty acid alkanolamides, amine oxides, alkyldimethylamine oxides, alkyl polyglucosides, saccharose esters, sorbitan esters, fatty acid glucamides, fatty acid N-methyl glucamides, ampholytes, betaines, sulfobetaines, N-(acylamidoalkyl) betaines, N-alkyl-β-aminopropionates, N-alkyl-β-iminopropionates, salts of long-chain primary amines, quarternary ammonium salts, quarternary phosphonium salts, tertiary sulfonium salts, pyridinium salts, imidazolinium salts, oxazolinium salts, esterquats, polyalkylene glycols, alkoxylated polyalkylene glycols, polysulfones, poly(2-hydroxyalkyl acrylates), poly(2-hydroxyalkyl methacrylates), ethylene oxide-propylene oxide block copolymers, polyethylene glycols, polypropylene glycols, polyethylene oxide resins, polypropylene oxides, salts of oligophosphates, salts of polyphosphates and mixtures thereof. The at least one surfactant (C) used according to the invention allows enhanced wetting of the reinforcement inserts to be treated. In particular, the surfactant (C) makes it possible to wet the inner surface of fiber bundles used as a reinforcement insert, thereby enabling improved stiffness.

According to another preferred embodiment of the present invention, the at least one surfactant (C) is a non-ionic surfactant and/or an anionic surfactant.

According to another preferred embodiment of the present invention, the at least one surfactant (C) is selected from the group consisting of sulfosuccinic acid derivatives, fatty alcohol sulfates, fatty acid ethoxylates, polyethylene glycol ethers alkylated on both sides, and ethylene oxide-propylene oxide block copolymers

According to the most preferred embodiment of the present invention, the at least one surfactant (C) is fatty acid ethoxylates and/or dioctyl sodium sulfosuccinate.

According to another preferred embodiment, the at least one surfactant (C) does not contain any poly(2-hydroxyalkyl acrylates).

According to another embodiment of the present invention, the at least one latex (D) is selected from the group consisting of styrene-butadiene-vinylpyridine copolymer, styrene-butadiene-vinylpyridine copolymer modified with carboxylic acid, styrene-butadiene copolymer, styrene-butadiene copolymer modified with carboxylic acid, nitrile-butadiene copolymer, natural latex, chloroprene latex and mixtures thereof.

According to another embodiment of the present invention, the at least one additive (E) is selected from the group consisting of
defoamers, preferably long-chain alcohols, high-polymeric glycols, trialkylmethylamines,
silicones or mixtures thereof, particularly preferably silicones in the form of silicone emulsions;
organic polymers, preferably polysaccharides, lignin sulfonic acids, kraft lignins;
fillers, preferably silicates;
dyes, preferably carbon black;
preservatives;
catalysts;
thickeners;
acids;
lyes;
polyhydric alcohols; and
mixtures thereof.

A further increase in the reaction speed of the adhesion promoter formulation according to the invention can be achieved by adding a catalyst in the form of a metal compound as the additive. Suitable catalysts are metal compounds of the metals sodium, potassium, cesium, strontium, silver, cadmium, barium, cerium, uranium, titanium, chromium, tin, antimony, manganese, iron, cobalt, nickel, copper, zinc, lead, calcium and/or zirconium. Among the metal compounds, those of zinc are preferred. Suitable compounds are zinc acetate, zinc sulfate, zinc carbonate, zinc oxide, zinc acetylacetonate and/or zinc chloride. Zinc acetate is most particularly preferred. The catalyst is preferably present in the dispersion in dissolved form, wherein the catalyst is preferably present in a concentration of 0.0001 to 0.1 mol/1000 g of the dipping bath compound.

According to another preferred embodiment of the present invention, the mean particle size d₅₀ of the capped MDI mixture is 0.1 to 2 μm, preferably 0.6 to 1.5 μm.

According to another preferred embodiment of the present invention, the particle size d₁₀₀ of the capped MDI mixture is 0.1 to no more than 6 μm, preferably 0.6 to 5 μm.

According to another preferred embodiment of the present invention, the capped MDI mixture has a number average molecular weight Mn in the range of 550 to 1200 g/mol and preferably of 700 to 1100 g/mol.

According to another preferred embodiment, the surfactant (C) satisfies the wetting test comprising the following steps:
dissolving 2 wt. % surfactant (C) in 50 ml water at 20° C. so that the liquid level of the solution of the surfactant (C) in the beaker is at least 3 cm high;
providing 0.15 g of an MDI mixture capped with ε-caprolactam (CL-MDI) having a number average molecular weight Mₙ of 740 g/mol and a particle size: d₅₀=1.2 μm, d₁₀₀=3.6 μm and a solids content of 100%;
using a spoon, adding the 0.15 g of CL-MDI to the resting, non-stirred surface of the solution of the dissolved surfactant (C) without the spoon making contact with the solution so that the CL-MDI floats on the solution of (C),
the surfactant (C) being considered to be wetting when no floating CL-MDI is visible any longer on the solution of (C) after 10 minutes (less than 20 wt. %), and
the surfactant (C) being considered to be non-wetting when on the solution of (C) more than 50 wt. % of CL-MDI floats on the solution of the surfactant (C) after 10 minutes.

It is furthermore preferred for the dipping bath compound to be free of tragacanth gum.

So as to produce a dipping bath, first deionized water is kept available in a vessel, preferably in a stirred vessel, at room temperature, and thereafter components (A), (B), (C), (D) and optionally (E) are stirred in.

### Method for Producing an Adhesive Reinforcement Insert

The present invention additionally relates to a method for producing an adhesive reinforcement insert, which comprises at least the following steps:
a) providing at least one reinforcement insert;
b) dipping the provided reinforcement insert in at least one dipping bath compound as defined above;
c) drying the reinforcement insert from step b) at 80 to 240° C.;
d) burning-in the coating of the reinforcement insert from step c) at 150 to 250° C.

Hereafter, preferred embodiments of the method according to the invention for producing an adhesive reinforcement insert will be described.

According to a preferred embodiment of the present invention, step c) is carried out at temperatures of 110 to 210° C., and preferably of 140 to 180° C.

According to another embodiment of the present invention, step d) is carried out at temperatures of 220 to 240° C.

According to another preferred embodiment of the present invention, the reinforcement insert is selected from a compound of the group consisting of polyamide 6, polyamide 66, polyethylene terephthalate, polyethylene naphthalate, rayon, aramid, cotton, basalt fibers, sisal, hemp, flax, coconut fibers, and mixtures thereof.

According to another preferred embodiment of the present invention, prior to step b), the reinforcement insert is dipped into an aqueous, solids-containing dipping bath compound, which contains at least one blocked isocyanate and which preferably does not contain any other components, the blocked isocyanate (A) containing MDI oligomers of Formula (I), n being an integer from 1 to 8, and containing MDI monomers.

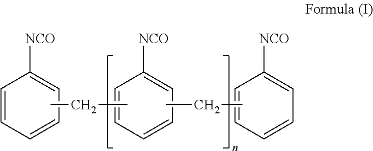

After the dipping step, it is preferable for the drying and burning-in of the layer to be carried out under the above-described conditions before step b) of the method according to the invention is carried out. The drying is preferably carried out at temperatures of 110 to 210° C., and particularly preferably of 140 to 180° C. It is furthermore preferred for the drying to be carried out over a time period of 30 to 120 seconds. Furthermore, the burning-in is carried out at temperatures of 220 to 240° C. It is furthermore preferred for the burning-in to be carried out over a time period of 20 to 120 seconds.

According to another preferred embodiment of the present invention, the pH value of the dipping bath compound is adjusted to be in the range of 8 to 12, preferably 9 to 11, before step b) of the method according to the invention is carried out, and before the at least one latex (D) is introduced into the dipping bath compound, that is, the dipping bath compound only contains components (A) and (C) before the pH value is set. Ammonia solution is preferably used as the base. The at least one latex (D) is introduced into the dipping bath compound before step b) is performed.

A tire cord or other reinforcement insert can be coated in a conventional coating machine, wherein the excess portion of the dipping bath is removed by way of a mechanical device and/or vacuum extraction at 1 to 5 mbar, the coating is first dried in a furnace at 100 to 240° C. for 20 to 120 seconds, and thereafter is burned-in at 200 to 250° C. for 20 to 120 seconds in a further furnace.

### Method for Producing a Reinforced Rubber Product

The present invention additionally relates to a method for producing a reinforced rubber product, which comprises the following steps:
(i) providing at least one layer of an adhesive reinforcement insert, produced by way of the method according to the invention as defined above;
(ii) embedding at least one layer of an adhesive reinforcement insert from step (i) in a rubber matrix in a pressing mold;
(III) pressing the layers from step (ii);
(iv) vulcanizing the reinforced rubber product from step (iii) at 140 to 210° C. and 5 to 110 bar for 5 to 45 minutes; and
(v) removing the reinforced rubber product from step (iv) from the pressing mold.

According to a preferred embodiment of the present invention, the reinforced rubber products are tires, for passenger cars, motorcycles as well as for commercial vehicles and aircraft, and technical rubber products, in particular conveyor belts, air springs, hoses (for example, train or bus bellows), and drive belts, for example, V-belts, ribbed V-belts, circular belts, flat belts, or toothed belts.

### Adhesive Reinforcement Insert

The present invention furthermore relates to an adhesive reinforcement insert that can be produced by the method according to the invention. The adhesive reinforcement insert is preferably a drive belt.

The reinforcement insert is preferably made up of fiber bundles containing 200 to 500 filaments, wherein the fiber bundles preferably have a fineness of 400 to 1700 dtex, and wherein the reinforcement insert is particularly preferably formed of 3 to 30 of these fiber bundles.

It is furthermore preferred for the reinforcement insert has a fineness of 4000 to 40000 dtex.

### Uses

The present invention also relates to the use of the adhesive reinforcement insert according to the invention for producing reinforced rubber products.

The present invention furthermore relates to the use of the dipping bath compound according to the invention for coating reinforcement inserts for rubber products.

The reinforced rubber products are preferably tires, for passenger cars, motorcycles, bicycles as well as for commercial vehicles and aircraft, and technical rubber products, in particular conveyor belts, air springs, hoses, and drive belts, for example, V-belts, ribbed V-belts, circular belts, flat belts, or toothed belts.

The subject matter according to the invention shall be described in more detail based on the following examples, without limiting the subject matter to the specific embodiments shown here.

### Measuring Methods

The following measuring methods were used within the scope of the present application.

Particle Size (d₅₀ or d₁₀₀ Value)

The particle size was determined using a powder or an aqueous dispersion in accordance with ISO 13320 at 23° C. by means of laser diffraction. The laser measurements were carried out in a Cilas 1064 granulometer made by Quantachrome GmbH (Germany).

### H-Test

The adhesion according to the H-test was determined in accordance with ASTM D4776 on a polyester cord (1100×3×3 dtex, $100, z50) at a vulcanization temperature of 160° C. and a vulcanization time of 15 minutes.

### Stiffness

The stiffness was determined in accordance with ASTM D885 on a polyester cord (1100×3×3 dtex, S 100, z50).

### Maximum Tensile Force

The maximum tensile force was determined in accordance with ASTM D885 on a polyester cord (1100×3×3 dtex, S 100, z50).

### Dip Pickup (DPU)

The DPU was determined in accordance with ASTM D2970 on a polyester cord (1100×3×3 dtex, S 100, z50).

### Degree of Surface Coverage

The surface coverage according to the H-test was determined by a visual inspection by comparing the corresponding tire material to internal samples that had a coverage of 0 to 100%. A coverage of 0% means that the adhesive reinforcement insert completely peeled off the rubber after the H-test, that is, the break took place in the boundary layer between the tire cord and the rubber. In contrast, a coverage of 100% means that no peeling of the adhesive reinforcement insert from the rubber took place, that is, the break occurred in the rubber.

### Solids Content

The solids content was determined by way of evaporation in a halogen dryer (Mettler HR 73 halogen dryer). For this purpose, approximately 3 g of the dipping bath compound is evenly distributed in an aluminum tray (diameter: 95 mm) on the bottom of the tray. The test duration is 25 minutes at 80° C. The selected display type was the drying type “Dry content (100-0). The average value from three determinations is shown.

### Number Average Molecular Weight (Mₙ)

The determination of the number average molecular weight (Mₙ) is carried out by means of gel permeation chromatography (GPC) with UV detection.

For the measurement, the samples are dissolved in THF (approximately 5 mg in 10 ml) and filtered through disposable syringe filters prior to being filled into vials.
Equipment: Waters 2690 Alliance
Software: Waters Millennium 32 GPC module
Column: PLgel 100 Å, particle size 3 μm
   Length 30.0 cm
   Inside diameter 7.5 mm
Wavelength UV detector: 254 nm
Eluent: THF
Flow rate: 1.0 ml/min

The number average molecular weight (Mₙ) is ascertained by way of conventional calibration. The calibration is carried out using polystyrene standards (masses 700, 1100 and 2000) and laurolactam (mass 197). Three determinations are carried out. The arithmetic mean of the molecular weight is described in g/mol. The THF solvent was procured in HPLC quality from EGT Chemie, Switzerland. The disposable filters are available from Macherey-Nagel GmbH & Co. KG, Germany, by the designation Chromafil A-45/25 (pore size 0.45 μm, filter diameter 25 mm). The disposable syringes are available from VWR International GmbH, Germany.

### Assessment of Wettability

For assessing the wettability, 2 wt. % surfactant was dissolved in 50 ml water at 20° C. so that the liquid level in the beaker is at least 3 cm high. In addition, 0.15 g of an MDI mixture capped with ε-caprolactam having a number average molecular weight Mₙ of 740 g/mol and a particle size: d₅₀=1.2 μm, d₁₀₀=3.6 μm and a solids content of 100% is prepared. The 0.15 grams of CL-MDI are added to the resting, non-stirred surfactant solution using a spoon, without the spoon making contact with the solution. The surfactant is considered to be wetting when no floating CL-MDI is visible any longer on the solution after 10 minutes (less than 20 wt. %). A surfactant is considered to be non-wetting when more than half of the added CL-MDI floats on top without wetting.

### Feedstock

The materials used in the examples and comparison examples are summarized in Table 1. Table 2 lists results of the assessment of the wettability by way of example. If the assessment is carried out without surfactant, more than half of the CL-capped MDI will also float unwetted on the water after 10 minutes. Considerably more than half of the CL-capped MDI likewise still floats on top after 10 minutes in the case of lignin sulfonate or tragacanth gum. It has even been shown that after 10 minutes, more than 90 wt. % of the CL-capped MDI floats on top in the case of lignin sulfonate or tragacanth gum, and that considerably more than 50 wt. % of the CL-capped MDI floats on top and was not wetted even after 24 hours. Even though tragacanth gum has no effect on wetting, it must be considered to be negative, the liquid is thickened, and the wettability of the solution decreases as a result of the tragacanth gum.

TABLE 1

| | |
|---|---|
| CL-blocked | Aqueous dispersion made of MDI mixture capped with ε- |
| isocyanates (A) | caprolactam and powdery, solid surfactant for dispersion |
| | stabilization, which according to the assessment of the |
| | wettability was considered to be non-wetting ^{a)} |
| | Solids content: 50 wt. % |
| | Number average molecular weight Mₙ of the MDI |
| | mixture capped with ε-caprolactam: 740 g/mol |
| | Volume average particle size: d₅₀ = 1.2 μm, d₁₀₀ = |
| | 3.6 μm |
| | Manufacturer: EMS-CHEMIE AG, Switzerland |
| Epoxy (B) | Glycerol triglycidyl ether, liquid |
| | Manufacturer: EMS-CHEMIE AG, Switzerland |
| Surfactant (C) | Stantex K 1701 (non-ionic fatty acid ethoxylates), liquid |
| | Solids content: 50 wt. % |
| | Manufacturer: Pulcra Chemicals |
| | Assessment of wettability: considered to be wetting |
| VP latex (D1) | Aqueous styrene-butadiene-vinylpyridine dispersion |
| | Solids content: 41 wt. % |
| | Trade name: Pliocord VP 106 |
| | Manufacturer: OMNOVA Solutions, USA |
| RFL (D2) | Aqueous dispersion made of resorcinol, formaldehyde, |
| | styrene-butadiene-vinylpyridine latex |
| | Weight ratio 1.0:0.6:9.2 |
| | Solids content: 20 wt. % |
| | Manufacturer: EMS-CHEMIE AG, Switzerland |
| Lignin | Lignin sulfonic acid, sodium salt sold by Carl Roth |
| sulfonate (E) | GmBH + Co. KG, Germany |

a) The capped MDI mixture (A1) was produced by capping the product “Voronate M600” available from DowDuPont
b) ε-caprolactam.

TABLE 2

| | | Wetting |
|---|---|---|
| Component | Manufacturer | behavior |
| Surfactant (C) | Stantex K 1701, liquid | wetting |
| | Solids content: 50 wt. % | |
| | Manufacturer: Pulcra Chemicals | |
| Lignin | Lignin sulfonic acid, sodium | non-wetting |
| sulfonate (E) | salt sold by Carl Roth GmBH + | |
| | Co. KG, Germany | |
| Tragacanth gum | Cerotrag 888, powder, sold by | not wetting, |
| | Roper GmbH | thickening |
| Water | | non-wetting |

A polyester cord (1100×3×3 dtex, S 100, z50) was used as the reinforcement insert.

This polyester cord is made up of polyethylene terephthalate having total adhesion of 9900 dtex. More particularly, three fiber bundles, which each contain 200 to 350 filaments (1100 dtex), are twisted in the S direction at 100 rotations per meter. Three of these triple bundles are then, in turn, twisted in the Z direction (opposite direction) at 50 rotations per meter.

The coating machine used was a pilot system from Mehler Engineering & Service GmbH, Fulda, Germany.

### EXAMPLES AND COMPARISON EXAMPLES

Table 3 summarizes the results of the examples according to the invention and of the comparison examples.

TABLE 3

| | | Comparison | | | | | |
|---|---|---|---|---|---|---|---|
| | | Examples | | Examples | | | |
| Components | Unit | 1 | 2 | 3 | 4 | 5 | 6 |
| 1st dipping bath | | | | | | | |
| CL-blocked isocyanates | Parts by | 5 | 5.0 | 7 | 7.0 | 14 | 14.0 |
| (A), solids content 50 | weight | | | | | | |
| wt. % | | | | | | | |
| Epoxy (B), liquid | Parts by | 1.0 | 1.0 | 1.35 | 1.35 | 2.7 | 2.7 |
| | weight | | | | | | |
| Surfactant (C), liquid | Parts by | — | — | 0.15 | 0.15 | 0.3 | 0.3 |
| Solids content 50 wt. % | weight | | | | | | |
| Water, deionized | Parts by | 94.0 | 94.0 | 91.5 | 91.5 | 83.0 | 83.0 |
| | weight | | | | | | |
| 2nd dipping bath | | | | | | | |
| RFL (D), | Parts by | 100.0 | — | 100.0 | — | 100.0 | — |
| Solids content 20 wt. % | weight | | | | | | |
| CL-blocked isocyanates | Parts by | — | 10.0 | — | 10.0 | — | 10.0 |
| (A), solids content 50 | weight | | | | | | |
| wt. % | | | | | | | |
| Latex VP (D) | Parts by | — | 39 | — | 39 | — | 39 |
| Solids content 41 wt. % | weight | | | | | | |
| Lignin sulfonate | Parts by | — | 3 | — | 3 | — | 3.0 |
| (E) >=93 wt. % | weight | | | | | | |
| Water, deionized | Parts by | 0.0 | 48.0 | 0.0 | 48.0 | 0.0 | 48.0 |
| | weight | | | | | | |
| Measurements | | | | | | | |
| Adhesion according to | N | 282 | 212 | 298 | 173 | 293 | 192 |
| H-test 160° C., | | | | | | | |
| 15 min, 130 kN | | | | | | | |
| Stiffness | cN/cord | 86 | 90 | 142 | 156 | 175 | 183 |
| Maximum tensile force | N/cord | 673 | 668 | 670 | 679 | 663 | 655 |
| Dip pickup (DPU) | % | 2.44 | 1.95 | 2.73 | 2.06 | 3.27 | 2.70 |

In Table 3, increased stiffness of the fiber bundles, which were treated by way of the dipping bath according to the invention of Examples 3 to 6, compared to Comparison Examples 1 and 2 is clearly apparent. In Examples 3 to 6, this can be attributed to the wetting surfactant (C) used, which also ensures high dip pickup even within the fiber bundles. When comparing Comparison Example 2 to Examples 4 and 6, it is apparent that the wetting surfactant, and not the lignin sulfonate, brings about good stiffness. Lignin sulfonate is not a wetting surfactant and in the assessment of the wettability does not show any effect on the CL-capped MDI in water. It is also apparent when comparing Comparison Examples 1 and 2 that lignin sulfonate has no influence on stiffness. Divided according to the latex system used, the increased dip pickup as a result of the wetting surfactant is also easily apparent. The dip pickup is considerably higher in Examples 3 and 5 than in Comparison Example 1, and it is higher in Examples 4 and 6 than in Comparison Example 2. The resulting enhancement of the stiffness is important for the use as a reinforcement insert (stiff cord). This is especially important for open-flanked belts to ensure that the fibers of the fiber bundles do not fray during cutting. It is furthermore apparent in Table 2 from comparisons within the latex systems that the adhesion according to the H-test and the maximum tensile force have not significantly changed.

1-16. (canceled)

17. An aqueous, solids-containing dipping bath compound for treating reinforcement inserts for rubber products, comprising the following components:
(A) at least one fully or partially blocked isocyanate;
(B) at least one epoxy;
(C) at least one surfactant for enhancing the wetting properties, the at least one surfactant (C) being selected from the group consisting of anionic surfactants, cationic surfactants, non-ionic surfactants, amphoteric surfactants, silicon-containing surfactants, perfluorinated surfactants, and hydrophilically modified polyolefins;
(D) at least one latex selected from the group consisting of styrene-butadiene-vinylpyridine copolymer, styrene-butadiene-vinylpyridine copolymer modified with carboxylic acid, styrene-butadiene copolymer, styrene-butadiene copolymer modified with carboxylic acid, nitrile-butadiene copolymer, natural latex, and chloroprene latex; and
(E) optionally at least one additive selected from the group consisting of
defoamers;
organic polymers;
fillers;
dyes;
preservatives;
catalysts;
thickeners;
acids;
lyes; and
polyhydric alcohols.

18. The aqueous, solids-containing dipping bath compound according to claim 17,
wherein the solids content of the dipping bath compound is 2 to 40 wt. % based on the total weight of the dipping bath compound.

19. The aqueous, solids-containing dipping bath compound according to claim 17,
wherein the dipping bath compound has the following composition, with the parts by weight in each case being based on the solids content of the dipping bath compound:
(A) 0.1 to 18 parts by weight;
(B) 0.4 to 8.0 parts by weight;
(C) 0.01 to 5.0 parts by weight;
(D) 5 to 40 parts by weight; and
(E) 0 to 20 parts by weight.

20. The aqueous, solids-containing dipping bath compound according to claim 17,
wherein the at least one isocyanate (A) has been blocked with a blocking agent selected from the group consisting of
monophenols;
lactams;
primary, secondary, tertiary alcohols, and glycol ether;
oximes;
enol-forming compounds;
secondary aromatic amines;
imides;
mercaptanes;
triazole, and
mixtures thereof.

21. The aqueous, solids-containing dipping bath compound according to claim 17,
wherein the at least one isocyanate (A) is selected from the group consisting of methylene diphenyl diisocyanate (MDI), toluene diisocyanate (TDI), and 1,5-naphthalene diisocyanate (NDI),
and/or that the at least one isocyanate (A) contains MDI derivatives, which are selected from the group consisting of MDI uretdione, adducts of MDI, and MDI oligomers with polyethylene glycol.

22. The aqueous, solids-containing dipping bath compound according to claim 21, wherein
the MDI is selected from the group consisting of 4,4′-MDI, 2,4′-MDI, 2,2′-MDI and mixtures thereof, wherein the content of 2,4′-MDI and 2,2′-MDI is less than 10 wt. %.

23. The aqueous, solids-containing dipping bath compound according to claim 21, wherein the mixture contains one or more MDI oligomers of Formula (I), wherein n in Formula (I) is an integer from 1 to 8:

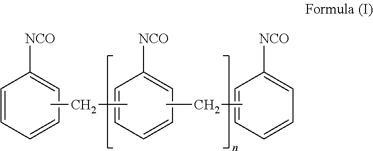

24. The aqueous, solids-containing dipping bath compound according to claim 17,
wherein the blocked MDI mixture has the following composition:
(I) 25 to 60 wt. % MDI monomers;
(II) 40 to 75 wt. % MDI oligomers; and
(III) 0 to 9 wt. % MDI derivatives,
with the contents of components (i) to (iii) adding up to 100 wt. %.

25. The aqueous, solids-containing dipping bath compound according to claim 17,
wherein the at least one epoxy (B) has a molecular weight of 50 to 2000 g/mol.

26. The aqueous, solids-containing dipping bath compound according to claim 25, wherein the at least one epoxy (B) is selected from the group consisting of water-soluble polyglycidyl ethers, epoxy novolac resins, polyfunctional alkylene epoxy resins, diglycidyl ethers, and bisphenol A on based resins.

27. The aqueous, solids-containing dipping bath compound according to claim 25, wherein the mean particle size d₅₀ of the blocked MDI mixture is 0.1 to 2 mm, and/or the particle size d₁₀₀ of the blocked MDI mixture is 0.1 to 6 mm, and/or the blocked MDI mixture has a number average relative molar mass Mₙ in the range of 550 to 1200 g/mol.

28. The aqueous, solids-containing dipping bath compound according to claim 17,
wherein the surfactant (C) satisfies a wetting test comprising the following steps:
dissolving 2 wt. % surfactant (C) in 50 ml water at 20° C. so that the liquid level of the solution of the surfactant (C) in the beaker is at least 3 cm high;
providing 0.15 g of an MDI mixture blocked with &-caprolactam (CL-MDI) having a number average molecular weight Mₙ of the MDI mixture blocked with &-caprolactam of 740 g/mol and a particle size: d₅₀=1.2 μm, d₁₀₀=3.6 μm and a solids content of 100%;
utilizing a spoon, adding the 0.15 g of CL-MDI to the resting, non-stirred surface of the solution of the dissolved surfactant (C) without the spoon making contact with the solution so that the CL-MDI floats on the solution of (C);
the surfactant (C) being considered to be wetting when no floating CL-MDI is visible any longer on the solution of (C) after 10 minutes (less than 20 wt. %); and
the surfactant (C) being considered to be non-wetting when on the solution of (C) more than 50 wt. % of CL-MDI floats on the solution of the surfactant (C) after 10 minutes.

29. The aqueous, solids-containing dipping bath compound according to claim 17,
wherein the dipping bath compound is free of tragacanth gum.

30. The aqueous, solids-containing dipping bath compound according to claim 17, wherein the surfactant (C) is selected from the group consisting of soaps, alkylbenzene sulfonates, linear alkylbenzene sulfonates, alkane sulfonates, ester sulfonates, methylester sulfonates, sulfosuccinic acid derivatives, α-olefin sulfonates, alkyl sulfates, fatty alcohol sulfates, fatty alcohol ether sulfates, fatty alcohol polyglycol ether sulfates, fatty alcohol polyglycol ether, dioctyl sodium sulfosuccinate, alkylphenol polyglycol ether, sorbitan fatty acid esters, ethoxylated sorbitan fatty acid esters, alkyl polyglucosides, fatty acid glucamides, fatty acid ethoxylates, fatty amine ethoxylates, ethoxylated triacylglycerols, polyethylene glycol ethers alkylated on both sides, alcohol ethoxylates, nonylphenol ethoxylates, polyglycerol fatty acid esters, fatty acid alkanolamides, amine oxides, alkyldimethylamine oxides, alkyl polyglucosides, saccharose esters, sorbitan esters, fatty acid glucamides, fatty acid N-methyl glucamides, ampholytes, betaines, sulfobetaines, N-(acylamidoalkyl) betaines, N-alkyl-β-aminopropionates, N-alkyl-β-iminopropionates, salts of long-chain primary amines, quarternary ammonium salts, quarternary phosphonium salts, tertiary sulfonium salts, pyridinium salts, imidazolinium salts, oxazolinium salts, esterquats, polyalkylene glycols, alkoxylated polyalkylene glycols, polysulfones, poly(2-hydroxyalkyl acrylates), poly(2-hydroxyalkyl methacrylates), ethylene oxide-propylene oxide block copolymers, polyethylene glycols, polypropylene glycols, polyethylene oxide resins, polypropylene oxides, salts of oligophosphates, salts of polyphosphates, and mixtures thereof;

31. A method for producing an adhesive reinforcement insert, comprising at least the following steps:
a) providing at least one reinforcement insert;
b) dipping the provided reinforcement insert in at least one dipping bath compound according to claim 17;
c) drying the reinforcement insert from step b) at 80 to 240° C.; and
d) burning-in the coating of the reinforcement insert from step c) at 150 to 250° C.

32. The method according to claim 31,
wherein the reinforcement insert is selected from a compound of the group consisting of polyamide 6, polyamide 66, polyethylene terephthalate, polyethylene naphthalate, rayon, aramid, cotton, basalt fibers, sisal, hemp, flax, coconut fibers, and mixtures thereof.

33. An adhesive reinforcement insert produced by the method according to claim 31.

34. The adhesive reinforcement insert according to claim 33,
wherein the reinforcement insert is made up of fiber bundles containing 200 to 500 filaments, and the fiber bundles having a fineness of 400 to 1700 dtex.

35. A method of producing reinforced rubber products comprising utilizing the adhesive reinforcement insert produced by the method of claim 33.
